(19) United States
(12) Patent Application Publication
(10) Pub. No.: US 2007/0056391 A1
(43) Pub. Date: Mar. 15, 2007

(54) Exchangeable pipette tip ejector assembly

(75) Inventor: Jacek Karbowniczek, Warsaw (PL)

Correspondence Address: PILLSBURY WINTHROP SHAW PITTMAN, LLP, P.O. BOX 10500, MCLEAN, VA, 22102, US

(73) Assignee: PZ HTL SPOLKA AKCYJNA, PL O3-230 WARSAW (PL)

(21) Appl. No.: 10/563,881

(22) PCT Filed: Jun. 18, 2004
(86) PCT No.: PCT/PL04/00046

§ 371 Date: Sep. 7, 2006

(30) Foreign Application Priority Data
Jul. 24, 2003 (PL) P 361430

(51) Int. Cl. B01L 3/02

(52) U.S. Cl. 73/864.14

(57) ABSTRACT

The exchangeable pipette tip assembly (3) is seated on the pipette body, and has the ejector push (6) linked to the ejector (8), while the ejector push button (6) has the push button toothed bar (9), and the ejector pusher (7) has the pusher toothed bar (10). Inside the pipette body the push button toothed wheel (11) is disposed, which is engaged with the push button toothed bar (9), and the pusher toothed wheel (12), which is engaged with the pusher toothed bar (10), while both toothed wheels (11, 12) are interconnected so that they make the same rotational movement around their common axis (13) of rotation rigidly fixed with respect to the handle (1).

### BACKGROUND OF THE INVENTION

1. Field of the Invention

The present invention relates to an exchangeable pipette tip ejector assembly.

2. Description of the Related Art

The U.S. Pat. No. 3,991,617 discloses a device for ejecting an exchangeable pipette tip, whereas the lower pipette end has conical shape to attach an exchangeable pipette tip on it. The device incorporates a rod placed in a passage disposed in the pipette body which slides therein parallel to the pipette axis, a member facilitating the rod upward and downward movements, and a spring forcing the rod downward. Moreover the device includes a detachable ejector which has its upper portion, middle portion, and lower portion, whereas the upper portion is connected to the rod lower part, the middle portion is placed in proximity to the pipette, while the lower end is guide-shaped, and has an ejecting member which encloses at least the lower, cylindrical pipette end in the vicinity of its conical portion, whereas the lower end of the ejecting member does not reach the upper edge of the exchangeable tip when it is seated on the pipette lower end. The rod has in its upper portion a push button which slides the ejecting member downward to eject the exchangeable pipette tip.

In turn, in the U.S. Pat. No. 5,435,197 a pipette is disclosed with a tip ejector which has elongated body. The pipette has an ejector on its body, slidable along the body to eject therefrom a tip mounted on the lower end of the body; as the extension of the ejector upper end, an arm is provided to slide the ejector along the body, and a manual link mechanism extending from the side of the body and joined linked to the arm with elements, by which the arm and ejector mechanism can be manually pressed downward to reject the tip from the body so that the force required to press is lower than the force required to eject the tip off the body, whereas the lever is pivoted on the arm and movable in the horizontal plane, while the inner lever end is on the side of the body connected to the body so that when the lever is pressed, its inner end makes a forced move on the body downward.

### SUMMARY OF THE INVENTION

The essence of the exchangeable pipette tip ejector assembly according to the present invention, the assembly seated on the pipette body, and has an ejector button linked to the ejector, is that the ejector push button has a push button toothed bar, and the ejector has an ejector toothed bar, whereas in the pipette body a push button toothed wheel is disposed inside the pipette body, which is engaged with the push button toothed bar, and the ejector toothed wheel which is engaged with the ejector toothed bar, while both toothed wheels are interconnected in such a way that they make the same rotational motion on their common axis of rotation rigidly fixed with respect to the handle.

Preferably the number of teeth of the push button toothed wheel is bigger than the number of teeth of the ejector toothed wheel.

The essence of a variety of the exchangeable pipette tip ejector assembly according to the invention, which is seated on the pipette body an has an ejector push button linked to the ejector, is that the ejector push button has the push button toothed bar, and the ejector pusher has the pusher toothed bar, and in the pipette body the push button toothed wheel is disposed, which is engaged with the push button toothed bar, and the pusher toothed wheel which is engaged with the pusher toothed bar, while both toothed wheels are interconnected in such a way that they make the same rotational movement around their common axis of rotation rigidly fixed with respect to the handle.

Preferably the number of teeth of the push button toothed wheel is bigger than the number of teeth of the ejector toothed wheel.

The advantage of the solution according to the invention is the reduction of force required to eject the pipette exchangeable tip.

### BRIEF DESCRIPTION OF THE DRAWINGS

The accompanying drawings, which are incorporated in, and form a part of the specification, illustrate the preferred embodiment of the present invention and, together with the description, serve to explain the principle of the invention. In the drawings:

FIG. 1 shows the general view of the pipette with the exchangeable tip ejector according to the invention, where a tip is seated on the pipette end; and

FIG. 2 shows the pipette from FIG. 1 when the tip is being ejected.

### DETAILED DESCRIPTION OF THE INVENTION

Reference will now be made in detail to the preferred embodiment of the invention, an example of which is illustrated in the accompanying drawings.

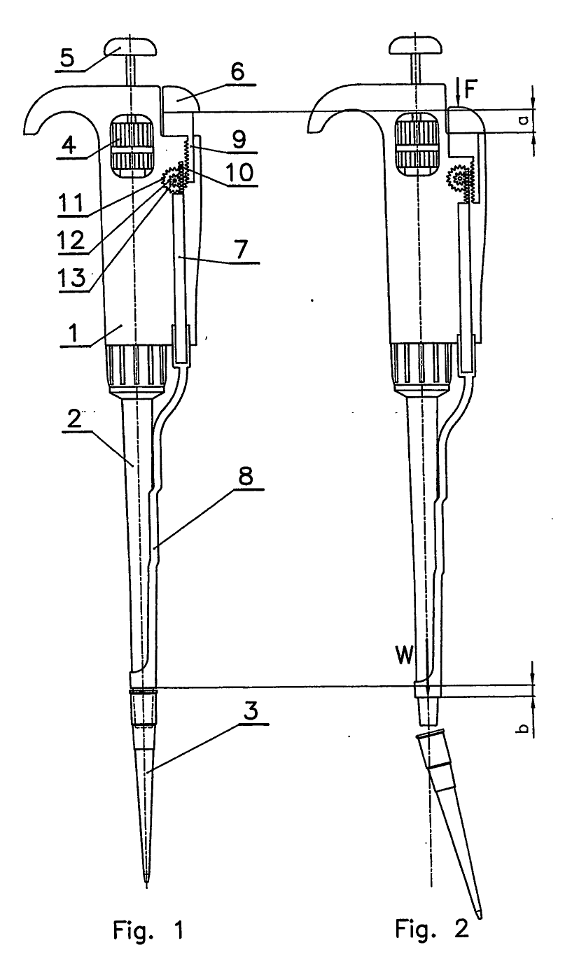

The ejector assembly, as shown in FIG. 1, is set on the pipette body, which in its upper portion has a handle (1), and in the lower portion a shaft (2) with an exchangeable pipette tip (3) seated upon. In the pipette handle (1) opening a knob (4) is disposed for setting the volume of the aspirated/dispensed. Further, in the handle (1) upper portion a pipetting push button (5) is disposed, and an ejector push button (6). The ejector push button (6) is linked via the ejector pusher (7) disposed in the handle (1), to the ejector (8), which in its lower portion encloses the shaft (2) with the exchangeable tip (3).

In the ejector assembly according to the invention, the ejector push button (6) has the push button toothed bar (9), and the ejector pusher (7) has the ejector toothed bar (10), whereas in the handle (1) the push button toothed wheel (11) is disposed, which is engaged with the push button toothed bar (9), and the pusher toothed wheel (12), which is engaged with the ejector pusher (7). Both toothed wheels (11, 12) are interconnected in such a way that they perform the same rotational motion around their common axis (13) of rotation rigidly fixed with respect to the handle (1).

In order to intake liquid by the pipette, an exchangeable tip (3) must be placed on the shaft (2), while the liquid is aspirated into the tip (3) by pressing and releasing the pipetting push button (5) linked to the aspirating and dispensing mechanism disposed inside the handle (1). After aspiration and dispension of liquid, the contaminated pipette tip (3) should be removed from the shaft (2). For this sake the ejector push button (6) is pressed, and the push button toothed bar (9) causes rotating of the push button toothed wheel (11), and pusher toothed wheel (12) around their axes. In effect, the rotating pusher toothed wheel (12) engaged with the pusher toothed bar (10) causes the motion of the ejector (8) toward the exchangeable pipette tip (3), and its ejection.

For the sake of reducing the force required to eject the exchangeable pipette tip (3) off the pipette, the number of the teeth of the push button toothed wheel (11) is bigger than the number of the teeth of the pusher toothed gear (12). Thanks to that, the travel of the ejector (8) move (segment (b)) is shorter than the travel of the ejector pushbutton (6) (segment (a)), while the magnitude of the pressing force (F) exerted on the ejector push button (6) is smaller than the force (W) required to eject the pipette tip (3). The relation of the segments (b/a) and forces (F/W) depends on the ratio of the number of teeth of the pusher toothed wheel (12) to the number of teeth of the push button toothed wheel (11).

We claim:

1. Exchangeable pipette tip ejector assembly which is seated on the pipette body, and has an ejector push button linked to the ejector, characterised by that the ejector push button (6) has a push button toothed bar (9), and the ejector (8) has an ejector toothed bar (9), while in the pipette body a push button toothed wheel (11) is disposed, which is engaged with the push button toothed bar (9), and an ejector toothed wheel, which is engaged with the ejector toothed bar, whereas both toothed wheels are interconnected in such a way, that they make the same rotational movement around common axis (13) of rotation rigidly fixed with respect to the handle (1).

2. The assembly according to the claim 1 characterised by that the number of teeth on the push button toothed wheel (11) is bigger than the number of teeth of the ejector toothed gear.

3. Exchangeable pipette tip ejector assembly which is seated on the pipette body, and has an ejector push button linked to the ejector, characterised by that the ejector push button (6) has a push button toothed bar (9), and the ejector pusher (7) has a pusher toothed bar (10), while in the pipette body a push button toothed wheel (11) is disposed, which is engaged with the push button toothed bar (9), and an ejector toothed wheel (12), which is engaged with the ejector toothed bar (10), whereas both toothed wheels (11, 12) are interconnected in such a way, that they make the same rotational movement around common axis (13) of rotation rigidly fixed with respect to the handle (1).

4. The assembly according to the claim 3 characterised by that the number of teeth on the push button toothed wheel (11) is bigger than the number of teeth of the pusher toothed gear (12).
